(19) United States
(12) Patent Application Publication
(10) Pub. No.: US 2026/0236287 A1
(43) Pub. Date: Aug. 13, 2026

(54) CLOUD SERVICE ACCESS PROCESSING METHOD, APPARATUS, DEVICE, AND STORAGE MEDIUM

(71) Applicant: Beijing Volcano Engine Technology Co., Ltd., Beijing (CN)

(72) Inventors: Daxiang KANG, Beijing (CN); Di FANG, Beijing (CN); Rui WANG, Beijing (CN); Mao GE, Beijing (CN)

(21) Appl. No.: 19/533,824

(22) Filed: Feb. 9, 2026

(30) Foreign Application Priority Data
Feb. 8, 2025 (CN) 202510142365.6

(51) Int. Cl. G06F 9/455

(52) U.S. Cl. CPC G06F 9/45558; G06F 2009/45595

(57) ABSTRACT

A cloud service access processing method includes: receiving, by a virtual switch, a cloud service access message being used to indicate access to a target cloud service with a destination virtual network address, the target cloud service being deployed across a plurality of availability zones, and maintaining a target mapping relationship for the target cloud service, which records a physical network address of an availability zone where the target cloud service is deployed, which is allocated, according to a principle of geographical proximity, to a source availability zone; determining, according to the target mapping relationship, a physical network address of an availability zone, as a destination physical network address; and sending the cloud service access message to the availability zone corresponding to the destination physical network address, and processing the cloud service access message by a server where the target cloud service is deployed in the availability zone.

### CROSS-REFERENCE TO RELATED APPLICATION(S)

This application claims priority to Chinese Application No. 202510142365.6 filed February 08, 2025, the disclosure of which is incorporated herein by reference in its entirety.

### TECHNICAL FIELD

The present disclosure relates to the technical field of virtual display, and in particular, to a cloud service access processing method, a cloud service access processing apparatus, a device, and a storage medium.

### BACKGROUND

In a large-scale cloud platform, a cloud service is usually provided to a tenant on a region basis. A region is divided in a geographical location and network latency dimension, for example, a Beijing region, a Shanghai region, etc. A region may usually include a plurality of availability zones (Availability Zone, AZ), with each availability zone having independent power and network infrastructures. Since the availability zones need to have a disaster isolation capability, their selected locations are usually relatively far apart (about 100 kilometers), and the latency between the availability zones ranges from 2 milliseconds to 3 milliseconds.

### SUMMARY

The present disclosure provides a cloud service access processing method, a cloud service access processing apparatus, a device, and a storage medium.

In a first aspect, an embodiment of the present disclosure provides a cloud service access processing method, including:

receiving, through a virtual switch, a cloud service access message, the cloud service access message being used to indicate access to a target cloud service with a destination virtual network address, the target cloud service being deployed across a plurality of availability zones, each of the plurality of availability zones allocating a corresponding physical network address for the destination virtual network address of the target cloud service, and maintaining a target mapping relationship for the target cloud service, and the target mapping relationship record a physical network address of an availability zone where the target cloud service is deployed, which is allocated, according to a principle of geographical proximity, to a source availability zone requesting to access the target cloud service;

determining, according to the target mapping relationship maintained for the target cloud service, a physical network address of an availability zone where the target cloud service is deployed, which is allocated to an availability zone to which the virtual switch belongs, as a destination physical network address; and

sending the cloud service access message to the availability zone corresponding to the destination physical network address and processing the cloud service access message through a server where the target cloud service is deployed in the availability zone.

In an optional implementation, determining, according to the target mapping relationship maintained for the target cloud service, the physical network address of the availability zone where the target cloud service is deployed, which is allocated to the availability zone to which the virtual switch belongs, as the destination physical network address includes:

sending, through the virtual switch, an address mapping request carrying an identifier of a source availability zone and the destination virtual network address to a target virtual private cloud gateway, and determining, by the target virtual private cloud gateway and according to the identifier of the source availability zone, the physical network address of the availability zone where the target cloud service is deployed, which is allocated to the source availability zone, from the target mapping relationship maintained for the target cloud service, as the destination physical network address; the identifier of the source availability zone being used to identify the availability zone to which the virtual switch belongs.

In an optional implementation, the target mapping relationship maintained for the target cloud service further records a physical network address of an availability zone where the target cloud service is deployed, which is allocated, according to the principle of geographical proximity, to a source availability zone where the target cloud service is not deployed.

In an optional implementation, the method further includes:

if the target virtual private cloud gateway not determining, from the target mapping relationship maintained for the target cloud service, the physical network address of the availability zone where the target cloud service is deployed, which is allocated to the source availability zone, determining, based on availability zone topology information and the principle of geographical proximity, a proximity access availability zone for the source availability zone from the plurality of availability zones where a target cloud service is deployed, and determining a physical network address, which is allocated by the proximity access availability zone for the destination virtual network address of the target cloud service, as the destination physical network address; where the availability zone topology information is used to represent a geographical location relationship between the source availability zone and the plurality of availability zones.

In an optional implementation, before receiving, through the virtual switch, the cloud service access message, the method further includes:

receiving a virtual network address allocated for a target cloud service through an anycast address allocation mode, and a virtual tunnel endpoint network address allocated for each of the plurality of availability zones where a target cloud service is deployed, the virtual tunnel endpoint network address being a physical network address allocated by a corresponding availability zone for the target cloud service.

In an optional implementation, sending the cloud service access message to the availability zone corresponding to the destination physical network address, and processing the cloud service access message through the server where the target cloud service is deployed in the availability zone includes:

sending the cloud service access message to a load balance node in the availability zone corresponding to the destination physical network address; forwarding, through the load balance node, the cloud service access message to the server where the target cloud service is deployed in the availability zone; and processing the cloud service access message by the server.

In an optional implementation, the method further includes:

in response to the presence of an abnormal availability zone among the plurality of availability zones where the target cloud service is deployed, deleting, from the target mapping relationship maintained for the target cloud service, a physical network address allocated by the abnormal availability zone for the destination virtual network address of the target cloud service.

In a second aspect, the present disclosure provides a cloud service access processing apparatus, including:

a first receiving module, configured to receive, through a virtual switch, a cloud service access message, the cloud service access message being used to indicate access to a target cloud service with a destination virtual network address, the target cloud service being deployed across a plurality of availability zones, each of the plurality of availability zones allocating a corresponding physical network address for the destination virtual network address of the target cloud service, and maintaining a target mapping relationship for the target cloud service, and the target mapping relationship recording a physical network address of an availability zone where the target cloud service is deployed, which is allocated, according to a principle of geographical proximity, to a source availability zone requesting to access the target cloud service;

a first determination module, configured to determine, according to the target mapping relationship maintained for the target cloud service, a physical network address of an availability zone where the target cloud service is deployed, which is allocated to an availability zone to which the virtual switch belongs, as a destination physical network address; and

a sending module, configured to send the cloud service access message to the availability zone corresponding to the destination physical network address, and process the cloud service access message through a server where the target cloud service is deployed in the availability zone.

In a third aspect, an embodiment of the present disclosure further provides an electronic device, including: a processor; and a memory, configured to store instructions that may be executed by the processor, where the processor is configured to read the instructions from the memory, and to execute the instructions to implement the cloud service access processing method provided by any of the embodiments of the present disclosure.

In a fourth aspect, an embodiment of the present disclosure further provides a computer-readable storage medium, where the storage medium stores a computer program, and the computer program is used to perform the cloud service access processing method provided by any of the embodiments of the present disclosure.

In a fifth aspect, the present disclosure provides a computer program product, including a computer program/instruction that, when executed by a processor, implements the above method.

### BRIEF DESCRIPTION OF THE DRAWINGS

The above and other features, advantages, and aspects of the embodiments of the present disclosure will become more apparent in combination with the drawings and with reference to the following specific embodiments. Throughout the drawings, the same or similar reference numbers refer to the same or similar elements. It should be understood that the drawings are schematic, and that parts and elements are not necessarily drawn to scale.

FIG. 1 is a schematic flowchart of a cloud service access processing method provided by an embodiment of the present disclosure;

FIG. 2 is a schematic diagram of a cloud service deployed across availability zones provided by an embodiment of the present disclosure;

FIG. 3 is a schematic diagram of another cloud service deployed across availability zones provided by an embodiment of the present disclosure;

FIG. 4 is a schematic diagram of another cloud service deployed across availability zones provided by an embodiment of the present disclosure;

FIG. 5 is a flowchart of cloud service access processing provided by an embodiment of the present disclosure;

FIG. 6 is a schematic structural diagram of a cloud service access processing apparatus provided by an embodiment of the present disclosure; and

FIG. 7 is a schematic structural diagram of a cloud service access processing device provided by an embodiment of the present disclosure.

### DETAILED DESCRIPTION OF EMBODIMENTS

Embodiments of the present disclosure will be described in more detail below with reference to the drawings. Although some embodiments of the present disclosure are shown in the drawings, it should be understood that the present disclosure may be implemented in various forms, and should not be interpreted as limited to the embodiments set forth herein. On the contrary, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the various steps described in the method implementations of the present disclosure may be executed in different orders and/or in parallel. In addition, the method implementations may include additional steps and/or omit the steps shown. The scope of the present disclosure is not limited in this regard.

The term “include/comprise” and its variants used herein are open-ended inclusions, that is, “include/comprise but not limited to”. The term “based on” means “at least partially based on”. The term “one embodiment” means “at least one embodiment”; the term “another embodiment” means “at least one other embodiment”; the term “some embodiments” means “at least some embodiments”. Related definitions of other terms will be given in the following description.

It should be noted that the concepts such as “first” and “second” mentioned in the present disclosure are only used to distinguish different apparatuses, modules, or units, and are not used to limit the order of functions performed by these apparatuses, modules, or units, or interdependence therebetween.

It should be noted that the modifications of “a”, “an” and “a plurality of” mentioned in the present disclosure are illustrative rather than restrictive, and those skilled in the art should understand that they should be interpreted as “one or more” unless the context clearly indicates otherwise.

The names of messages or information exchanged between a plurality of apparatuses in the implementations of the present disclosure are only used for illustrative purposes, and are not used to limit the scope of these messages or information.

A cloud service refers to a model that provides various computing resources and services through the Internet. It allows users to access and use these resources on demand without having to maintain hardware and software infrastructure on their own. Cloud services are typically provided by cloud service providers.

A virtual private cloud (virtual private cloud, VPC) provides a secure and isolated network environment through logical network isolation. Users may define a virtual network in the VPC that is no different from a traditional network, and at the same time provides advanced network services such as an elastic network interconnection protocol and a security group. From the perspective of services, a VPC refers to a cloud computing service used to isolate a part of public cloud resources for a certain user to privately use. The VPC is managed by the public cloud and runs on public resources, but it may ensure that resources between each user are isolated, and any user is not affected by other users when using the VPC. Exemplarily, the virtual private network includes a plurality of computing instances, such as virtual machines, with a specified network relationship. As a possible implementation of a virtual machine, the virtual machine in the embodiment of the present application may be an elastic compute service (elastic compute service, ECS).

A virtual machine (virtual machine, VM) refers to a complete computer system with a complete hardware system function and running in a completely isolated environment, which is obtained through simulation by a virtualization technology. A part of instruction subsets of the virtual machine may be processed in a host, and the other part of the instruction subsets may be executed in an emulation manner. Users may purchase cloud services by renting virtual machines.

In a large-scale cloud platform, a cloud service is usually provided to a tenant in a unit of region. A region is divided in a geographical location and network latency dimension, for example, a Beijing region, a Shanghai region, etc. A region may usually include a plurality of availability zones (Availability Zone, AZ), and each availability zone has independent power and network facilities. Since the availability zones need to have a disaster isolation capability, the availability zones are usually located far away (about 100 kilometers), and the latency between the availability zones is between 2 milliseconds and 3 milliseconds.

Obviously, when a tenant’s client accesses a cloud service, if an availability zone to which a server that processes a cloud service access request belongs is far away from an availability zone in which the tenant’s client is located, the problem of high cloud service access latency will occur.

Therefore, in the cloud service access processing method provided by the embodiment of the present disclosure, a cloud service access message is first received through a virtual switch, where the cloud service access message is used to indicate access to a target cloud service with a destination virtual network address, the target cloud service is deployed in each of a plurality of availability zones, and a target mapping relationship is maintained for the target cloud service, where the target mapping relationship records a physical network address of an availability zone where a target cloud service is deployed, which is allocated, according to a principle of geographical proximity, to a source availability zone requesting to access the target cloud service; then, a physical network address of an availability zone where the target cloud service is deployed, which is allocated to an availability zone to which the virtual switch belongs, is determined as a destination physical network address according to the target mapping relationship maintained for the target cloud service; and then, the cloud service access message is sent to the availability zone corresponding to the destination physical network address, and the cloud service access message is processed through a server in the availability zone, where the target cloud service is deployed at the server.

In the embodiment of the present disclosure, a target mapping relationship is maintained for the target cloud service in advance, and the target mapping relationship records a physical network address of an availability zone where the target cloud service is deployed; the physical network address is allocated, according to a principle of geographical proximity, to a source availability zone requesting to access the target cloud service. Therefore, after a cloud service access message from any availability zone is received, a physical network address corresponding to a proximity availability zone may be determined as a destination physical network address of the cloud service access message based on the target mapping relationship, so that the cloud service access message is processed by a server where the target cloud service is deployed in the proximity availability zone, thereby reducing cloud service access latency and improving access message processing efficiency.

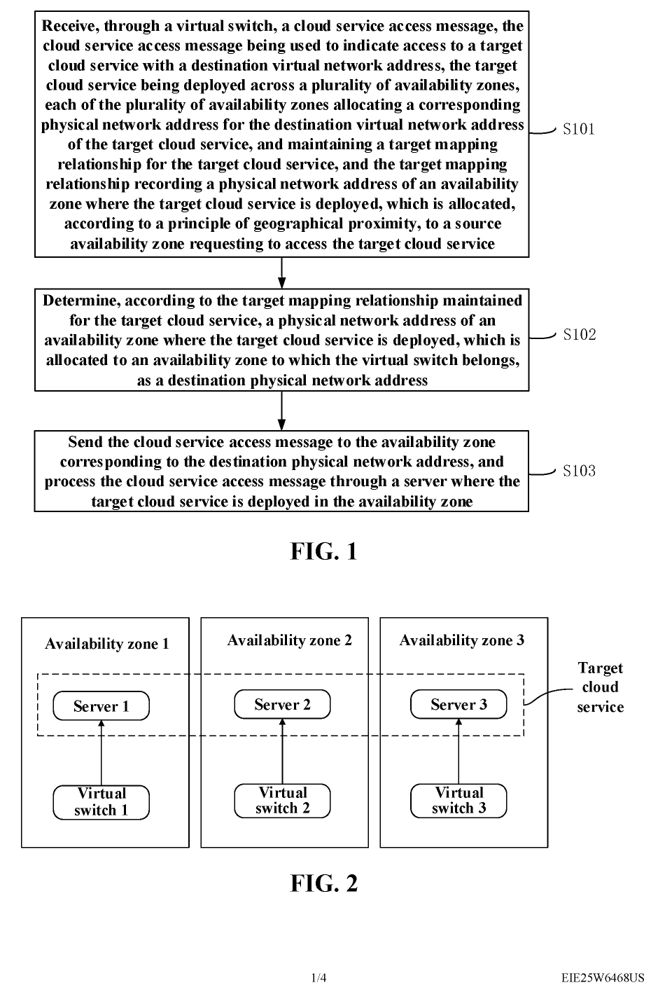

Based on this, an embodiment of the present disclosure provides a cloud service access processing method. FIG. 1 is a schematic flowchart of a cloud service access processing method provided by an embodiment of the present disclosure. The method may be executed by a cloud service access processing apparatus, where the apparatus may be implemented by software and/or hardware, and may generally be integrated in an electronic device. As shown in FIG. 1, the method includes the following steps.

At S101, a cloud service access message is received through a virtual switch, the cloud service access message being used to indicate access to a target cloud service with a destination virtual network address, the target cloud service being deployed across a plurality of availability zones, each of the plurality of availability zones allocating a corresponding physical network address for the destination virtual network address of the target cloud service, and maintaining a target mapping relationship for the target cloud service, and the target mapping relationship recording a physical network address belonging to an availability zone where the target cloud service is deployed, which is allocated, according to a principle of geographical proximity, to a source availability zone requesting to access the target cloud service.

In the embodiment of the present disclosure, the cloud service may include a database service, a platform as a service (PaaS), a software as a service (SaaS), a machine learning service, etc., and the target cloud service may be any cloud service. The cloud service runs on a virtualization layer created on a physical machine through a virtualization technology. The virtualization technology is a technology that abstracts physical resources into virtual resources, allows virtual machines to be created on the physical machine, and forms the virtualization layer by running the virtual machines. The virtualization layer is used to manage the allocation of physical resources and the running of the virtual machines, so that the cloud service may be deployed and run on the virtual machines.

The target cloud service is deployed in each of the plurality of availability zones. Each of the availability zones may include one or more physical machines as virtual machine running carriers, and the physical machines may be configured and managed to support different cloud services. FIG. 2 is a schematic diagram of a target cloud service deployed across availability zones provided by an embodiment of the present disclosure. The target cloud service is deployed in availability zone 1, availability zone 2, and availability zone 3. A virtual switch 1 is further deployed on a physical machine in the availability zone 1, a virtual switch 2 is further deployed on a physical machine in the availability zone 2, and a virtual switch 3 is further deployed on a physical machine in the availability zone 3.

The target cloud service is provided by a cloud service provider, which is mainly responsible for cloud services and managing cloud service infrastructure. The cloud service provider relies on hardware resources provided by a resource provider to deploy and maintain its cloud service platform. The resource provider refers to an organization or enterprise that provides underlying hardware resources, and the hardware resources may include servers, storage devices, network devices, etc. A cloud service consumer refers to an individual, an organization or an enterprise that uses resources and services provided by the cloud service, and is also referred to as a tenant. The cloud service consumer uses the cloud service to support business processes, develop applications, or store large-scale data, etc.

The cloud service access processing method provided by the embodiment of the present disclosure may be applied to any physical machine in any availability zone, a basic virtual switch (BVS) being deployed on the physical machine, and the virtual switch is used to receive a cloud service access message.

In the embodiment of the present disclosure, the cloud service access message is used to indicate the target cloud service with the destination virtual network address.

In practical applications, when creating the target cloud service, a corresponding destination virtual network address is usually allocated to the target cloud service. After receiving the cloud service access message carrying the destination virtual network address, the virtual switch may forward the cloud service access message to a server of the target cloud service, so that the server processes the cloud service access message, such as querying a database, executing a computing task, etc.

The destination virtual network address refers to a virtual network address allocated for the target cloud service in advance, and a client device corresponding to the cloud service consumer may access the server in the target cloud service through the destination virtual network address.

In the embodiment of the present disclosure, the target cloud service is deployed in each of the plurality of availability zones, and each of the plurality of availability zones allocates a corresponding physical network address for the destination virtual network address of the target cloud service.

As shown in FIG. 2, the destination virtual network address of the target cloud service is represented as service IP1. The target cloud service is deployed in availability zone 1, availability zone 2, and availability zone 3. The physical network address allocated by the availability zone 1 for the destination virtual network address service IP1 may be represented as vtep IP1, the physical network address allocated by the availability zone 2 for the destination virtual network address service IP1 may be represented as vtep IP2, and the physical network address allocated by the availability zone 3 for the destination virtual network address service IP1 may be represented as vtep IP3. It may be understood that the destination virtual network address service IP1 corresponds to a plurality of physical network addresses, namely vtep IP1, vtep IP2, and vtep IP3.

In the embodiment of the present disclosure, each of the plurality of availability zones maintains a target mapping relationship for the target cloud service, and the target mapping relationship records a physical network address of an availability zone where the target cloud service is deployed, and the physical network address is allocated, according to the principle of geographical proximity, to the source availability zone requesting to access the target cloud service.

In the embodiment of the present disclosure, the source availability zone requesting to access the target cloud service refers to an availability zone to which the virtual switch receiving the cloud service access message belongs. As shown in FIG. 2, when the cloud service access message is received through the virtual switch 2, the corresponding source availability zone is availability zone AZ2 to which the virtual switch 2 belongs; and when the cloud service access message is received through the virtual switch 3, the corresponding source availability zone is availability zone AZ3 to which the virtual switch 3 belongs.

The physical network address belonging to the availability zone where the target cloud service is deployed and allocated to the source availability zone, may be used to identify which of the plurality of availability zones (where the target cloud service is deployed) will specifically process the cloud service access message requesting to access the target cloud service.

As shown in FIG. 2, the target cloud service is deployed among availability zone 1, availability zone 2, and availability zone 3. Based on the principle of geographical proximity, the physical network address belonging to the availability zone where the target cloud service is deployed allocated to source availability zone AZ1 is vtep IP1; the physical network address belonging to the availability zone where the target cloud service is deployed and allocated to source availability zone 2 is vtep IP2; and the physical network address belonging to the availability zone where the target cloud service is deployed and allocated to source availability zone 3 is vtep IP3. Therefore, the target mapping relationship maintained for the target cloud service is: AZ1-vtep IP, AZ2-vtep IP2, and AZ3-vtep IP3.

In the embodiment of the present disclosure, when the target cloud service is deployed in the availability zone to which the virtual switch belongs, the cloud service access message received by the virtual switch is processed by the server in the target cloud service in the availability zone to which the virtual switch belongs. It may be understood that the cloud service access message from the availability zone to which the virtual switch belongs may usually be processed by the server in the availability zone to which the virtual switch belongs. As shown in FIG. 2, when the availability zone to which the virtual switch 1 belongs is AZ1, vtep IP1 may be determined, based on the above target mapping relationship, as the physical network address of the availability zone where the target cloud service is deployed, which is allocated to the availability zone to which the virtual switch belongs.

In an optional implementation, the target mapping relationship maintained for the target cloud service further records a physical network address belonging to an availability zone where the target cloud service is deployed and allocated, according to the principle of geographical proximity, to a source availability zone in which the target cloud service is not deployed.

In the embodiment of the present disclosure, when the target cloud service is not deployed in the availability zone to which the virtual switch belongs, the cloud service access message received by the virtual switch is processed by the server in the availability zone where the target cloud service is deployed that is geographically closer to the availability zone to which the virtual switch belongs.

FIG. 3 is a schematic diagram of another cloud service deployed across availability zones provided by an embodiment of the present disclosure. The target cloud service is deployed in availability zone 1 and availability zone 2, and availability zone 3 is not deployed with the target cloud service. A virtual switch 1 is further deployed on a physical machine in the availability zone 1, a virtual switch 2 is further deployed on a physical machine in the availability zone 2, and a virtual switch 3 is further deployed on a physical machine in the availability zone 3.

As shown in FIG. 3, still using an example in which a physical network address allocated by the availability zone 1 for the destination virtual network address service IP1 may be represented as vtep IP1, and a physical network address allocated by the availability zone 2 for the destination virtual network address service IP1 may be represented as vtep IP2, the destination virtual network address service IP1 corresponds to vtep IP1 and vtep IP2. According to the principle of geographical proximity, the physical network address vtep IP2 of the availability zone AZ2 in which the target cloud service is deployed may be determined as the physical network address allocated to the source availability zone AZ3 where the target cloud service is not deployed. It may be understood that the cloud service access message received by the virtual switch in the availability zone AZ3 is processed by the server of the target cloud service deployed in the availability zone ZA2, which is geographically closer to the availability zone AZ3.

In the embodiment of the present disclosure, after the cloud service access message is received through the virtual switch, the physical network address belonging to the availability zone where the target cloud service is deployed and allocated to the availability zone to which the virtual switch belongs, may be determined as the destination physical network address according to the target mapping relationship maintained for the target cloud service, and the cloud service access message is forwarded and processed based on the destination physical network address.

In an optional implementation, before the cloud service access message is received through the virtual switch, a virtual network address allocated for the target cloud service through an anycast address allocation mode and a virtual tunnel endpoint network address allocated for each of the plurality of availability zones in which the target cloud service is deployed may also be received. The virtual tunnel endpoint network address is the physical network address allocated by the corresponding availability zone for the target cloud service.

When the virtual network address is allocated for the target cloud service through the anycast address allocation mode, an availability zone to which the virtual network address accesses proximately is specified. Generally, the availability zone to which the virtual network address accesses proximately is consistent with the availability zone to which the virtual switch belongs (that is, the availability zone in which the tenant’s client device is located).

In practical applications, in a scenario where a certain availability zone is not deployed with the target cloud service, a correspondence between an identifier of the availability zone in which the target cloud service is not deployed and an identifier of the availability zone in which the target cloud service is deployed may be established, so that a plurality of availability zone identifiers may correspond to the same physical network address, thereby enabling the availability zone in which the target cloud service is not deployed to access the availability zone in which the target cloud service is deployed proximately.

In addition, in the scenario where a certain availability zone is not deployed with the target cloud service, based on availability zone topology information, the availability zone in which the target cloud service is not deployed may also access the availability zone in which the target cloud service is deployed proximately.

S102: According to the target mapping relationship maintained for the target cloud service, a physical network address of an availability zone where the target cloud service is deployed, which is allocated to an availability zone to which the virtual switch belongs, is determined as a destination physical network address.

In the embodiment of the present disclosure, after the cloud service access message used to indicate access to the target cloud service is received through the virtual switch, the physical network address — belonging to the availability zone where the target cloud service is deployed and allocated to the availability zone of the virtual switch — may be determined as the destination physical network address according to the above target mapping relationship maintained for the target cloud service.

Since the virtual switch is deployed on the physical machine in the availability zone, after the cloud service access message is received based on the virtual switch, the physical machine on which the virtual switch is located may be determined as the availability zone to which the virtual switch belongs. As shown in FIG. 2, after receiving the cloud service access message, the virtual switch 1 may determine the availability zone 1 in which the virtual switch 1 is located as the availability zone to which the virtual switch belongs, and determine, according to the target mapping relationship maintained for the target cloud service, the physical network address of the availability zone where the target cloud service is deployed as the destination physical network address, and the physical network address is allocated to the availability zone to which the virtual switch belongs.

In the embodiment of the present disclosure, when the target cloud service is accessed through the destination virtual network address, it is possible to find the physical network address (that is, the destination physical network address) — corresponding to the availability zone geographically closer to the availability zone to which the virtual switch belongs — among the plurality of physical network addresses allocated for the destination virtual network address of the target cloud service. This search is based on the mapping relationship, which records the physical network addresses of the availability zones where the target cloud service is deployed; these physical network addresses are allocated, according to the principle of geographical proximity, to the source availability zones requesting to access the target cloud service. After determining the destination physical network address, the cloud service access message is sent to the availability zone corresponding to the destination physical network address based on the destination physical network address. As such, the cloud service access message may subsequently be processed by using the server of the target cloud service deployed in the availability zone, thereby reducing the cloud service access latency and improving the access efficiency.

In practical applications, there may be an abnormal availability zone among the plurality of availability zones in which the target cloud service is located, and the server in the abnormal availability zone cannot run normally. Therefore, when the availability zone corresponding to the destination physical network address happens to be the abnormal availability zone, if the server in the abnormal availability zone continues to be used to process the cloud service access message, the problem of cloud service access failure will occur.

In the embodiment of the present disclosure, in response to the presence of an abnormal availability zone among the plurality of availability zones where the target cloud service is deployed, a physical network address allocated by the abnormal availability zone for the destination virtual network address of the target cloud service may be deleted from the target mapping relationship maintained for the target cloud service, so as to improve the success rate of cloud service access.

Exemplarily, it is assumed that the mapping relationship between the availability zone identifier and the physical network address allocated for the target cloud service is: AZ1 corresponds to vtep IP, AZ2 corresponds to vtep IP2, and AZ3 corresponds to vtep IP3. When there is an abnormality in the availability zone 1 corresponding to AZ1, the availability zone identifier of the abnormal availability zone may be deleted from the above mapping relationship to obtain the updated mapping relationship: AZ2 corresponds to vtep IP2, and AZ3 corresponds to vtep IP3.

S103: The cloud service access message is sent to the availability zone corresponding to the destination physical network address, and the cloud service access message is processed through a server where the target cloud service is deployed in the availability zone.

In practical applications, a server is a high-performance computer used to run applications and store data to provide users with various services. The server may include a physical server and a virtual server. Cloud service providers may use a large number of servers to build their data centers and provide users with various cloud services. It may be understood that the server is the foundation of the cloud service.

In the embodiment of the present disclosure, after the physical network address corresponding to the availability zone identifier of the availability zone to which the virtual switch belongs is determined as the destination physical network address according to the mapping relationship maintained for the target cloud service, the cloud service access message is sent to the availability zone corresponding to the destination physical network address, so that the cloud service access message is processed by the server in the availability zone, where the target cloud service is deployed at the server.

In the embodiment of the present disclosure, the physical network address allocated to the availability zone to which the virtual switch belongs may be used to represent an address of the server in the availability zone in which the target cloud service is deployed, or an address of the load balance node in the availability zone where the target cloud service is deployed. When the destination physical network address is used to represent the address of the load balance node in the availability zone, the cloud service access message is first sent to the load balance node based on the destination physical network address, and then the cloud service access message is forwarded to the server where the target cloud service is deployed in the availability zone, based on a load balance algorithm or a load balance policy, so that the cloud service access message is processed by the server.

Since the availability zone corresponding to the destination physical network address is geographically closer to the availability zone to which the virtual switch belongs, sending the cloud service access message to the availability zone corresponding to the destination physical network address, so that the cloud service access message is processed by the server in the availability zone to which the proximity virtual switch belongs, may reduce the access latency of the cloud service.

In the cloud service access processing method provided by the embodiment of the present disclosure, a cloud service access message is first received through a virtual switch, where the cloud service access message is used to indicate access to a target cloud service with a destination virtual network address, the target cloud service is deployed in each of a plurality of availability zones, and a target mapping relationship is maintained for the target cloud service, where the target mapping relationship records a physical network address of an availability zone where the target cloud service is deployed, which is allocated, according to a principle of geographical proximity, to a source availability zone requesting to access the target cloud service; then, a physical network address belonging to an availability zone where the target cloud service is deployed and allocated to an availability zone to which the virtual switch belongs, is determined as a destination physical network address according to the target mapping relationship maintained for the target cloud service; and then, the cloud service access message is sent to the availability zone corresponding to the destination physical network address, and the cloud service access message is processed through a server where the target cloud service is deployed in the availability zone.

In the embodiment of the present disclosure, the target mapping relationship is maintained for the target cloud service in advance, and the target mapping relationship records a physical network address of an availability zone where the target cloud service is deployed — the physical network address is allocated, according to a principle of geographical proximity, to a source availability zone requesting to access the target cloud service. Therefore, after a cloud service access message from any availability zone is received, a physical network address corresponding to a proximity availability zone may be determined as a destination physical network address of the cloud service access message based on the target mapping relationship, so that the cloud service access message is processed by a server in the proximity availability zone where the target cloud service is deployed, thereby reducing cloud service access latency and improving access message processing efficiency.

In practical applications, a virtual private cloud (VPC) provides an isolated and private virtual network environment for cloud services. Through the virtual private cloud, a cloud service may be deployed in a subnet isolated from the public network, thereby improving the security of the cloud service.

The target virtual private cloud gateway (RCM) is a component in the virtual private cloud responsible for mapping a virtual network address (overlay IP) and a physical network address (underlay IP). The physical network address refers to an IP address used at a physical network level, which constitutes the network infrastructure and is responsible for the actual data packet transmission, and the virtual network address is an IP address used in a logical network layer constructed on the physical network. Therefore, after the cloud service access message is received, the destination physical network address corresponding to the destination virtual network address indicated by the cloud service access message needs to be determined before the cloud service access message may be forwarded.

In an optional implementation, in order to determine a destination physical network address, a cloud service access message is first received through a virtual switch. Then, an address mapping request carrying an identifier of a source availability zone and a destination virtual network address is sent through the virtual switch to a target virtual private cloud gateway (RCM). Next, according to the identifier of the source availability zone, a physical network address of an availability zone where a target cloud service is deployed — the physical network address is allocated to the source availability zone, is determined by the target virtual private cloud gateway (RCM) from a target mapping relationship maintained for the target cloud service, as the destination physical network address.

The identifier of the source availability zone may be used to identify an availability zone to which the virtual switch belongs. Exemplarily, assuming that the region in which a tenant’s client device is located is an availability zone 3, when accessing the target cloud service through the client device, the tenant will send a cloud service access message to a virtual switch in the availability zone 3. Therefore, when receiving the above cloud service access message, the virtual switch may determine an identifier corresponding to the availability zone 3 in which the virtual switch is located as the identifier of the source availability zone, and encapsulate the identifier of the source availability zone and the destination virtual network address in the address mapping request, to send to the target virtual private cloud gateway.

In the embodiment of the present disclosure, the address mapping request carrying the identifier of the source availability zone and the destination virtual network address is sent to the target virtual private cloud gateway. As such, the target virtual private cloud gateway may determine, from the target mapping relationship maintained for the target cloud service and according to the identifier of the source availability zone, a physical network address where the target cloud service is deployed and which is allocated to the identifier of the source availability zone, as the destination physical network address.

The target mapping relationship maintained for the target cloud service records a physical network address of an availability zone where the target cloud service is deployed — the physical network address is allocated, according to the principle of geographical proximity, to the source availability zone requesting to access the target cloud service. As shown in FIG. 3, it is assumed that the address mapping request carries the identifier “AZ3” of the source availability zone and the destination virtual network address “service IP1”. Then, the physical network address “vtep IP2” corresponding to the identifier “AZ3” of the source availability zone may be determined as the destination physical network address according to the destination mapping relationship, so that the cloud service access message may be forwarded subsequently based on the destination physical network address.

It may be seen that the embodiment of the present disclosure is capable of determining, from the target mapping relationship maintained for the target cloud service, the physical network address belonging to the availability zone where the target cloud service is deployed and allocated to the identifier of the source availability zone, as the destination physical network address, based on the identifier of the source availability zone. Since the availability zone corresponding to the destination physical network address is geographically closer to the availability zone to which the virtual switch belongs, the cloud service access time may be saved and the access efficiency may be improved.

In an optional implementation, if the target virtual private cloud gateway not determining, from the target mapping relationship maintained for the target cloud service, the physical network address of the availability zone where the target cloud service is deployed — the physical network address is allocated to the identifier of the source availability zone, a proximity access availability zone is determined for the source availability zone from the plurality of availability zones where the target cloud service is deployed, based on the availability zone topology information and the principle of geographical proximity, and a physical network address, which is allocated by the proximity access availability zone for the destination virtual network address of the target cloud service, is determined as the destination physical network address.

The availability zone topology information is used to represent a geographical location relationship between the source availability zone and the plurality of availability zones. Through the availability zone topology information, an availability zone geographically closer to the source availability zone may be determined from the plurality of availability zones in which the target cloud service is deployed.

In the embodiment of the present disclosure, if the physical network address of the availability zone where the target cloud service is deployed — the physical network address is allocated to the source availability zone — is not determined from the target mapping relationship maintained for the target cloud service, it indicates that the availability zone allocated to the source availability zone is not deployed with the target cloud service, or the availability zone where the target cloud service is deployed — the physical network address is allocated to the source availability zone — may be abnormal, and the physical network address of the availability zone where the target cloud service is deployed — the physical network address is allocated to the source availability zone — has been deleted from the target mapping relationship. At this time, based on the availability zone topology information and the principle of geographical proximity, the proximity access availability zone may be re-determined from the plurality of availability zones to which the target cloud service belongs, and the physical network address allocated by the proximity access availability zone for the destination virtual network address of the target cloud service may be used as the destination physical network address.

Specifically, if the target virtual private cloud gateway does not determine, from the target mapping relationship maintained for the target cloud service, the physical network address of the availability zone where the target cloud service is deployed — the physical network address is allocated to the source availability zone, an availability zone that meets the principle of geographical proximity with the availability zone to which the virtual switch belongs is first determined, the availability zone that meets the proximity principle is determined as the proximity access availability zone, and the physical network address corresponding to the proximity access availability zone is determined as the destination physical network address. If no availability zone that meets the principle of geographical proximity is found, an availability zone geographically closer to the availability zone to which the virtual switch belongs is determined from the plurality of availability zones based on the availability zone topology information, the availability zone geographically closer is determined as the proximity access availability zone, and the physical network address corresponding to the proximity access availability zone is determined as the destination physical network address.

In an optional implementation, according to the principle of geographical proximity, a correspondence between an identifier of the source availability zone in which the target cloud service is not deployed and an identifier of the availability zone in which the target cloud service is deployed may be established, that is, a plurality of availability zone identifiers may correspond to the same physical network address, thereby enabling the availability zone in which the target cloud service is not deployed to access the availability zone in which the target cloud service is deployed proximately.

Exemplarily, in the scenario shown in FIG. 3, the above mapping relationship may include: AZ1 corresponds to the physical network address vtep IP1, and both AZ2 and AZ3 correspond to the physical network address vtep IP2. Assuming that the availability zone identifier of the availability zone to which the virtual switch belongs is AZ3, the destination physical network address is vtep IP2.

In practical applications, since the physical network address corresponding to both the availability zone identifier 2 and the availability zone identifier 3 is vtep IP2, and the target cloud service is not deployed in the availability zone 3, after the address mapping request carrying the target availability zone 3 and the destination virtual network address is sent to the virtual private cloud gateway through the virtual switch 3, the destination physical network address obtained by the virtual private cloud gateway based on the target availability zone 3 may be vtep IP2. At this time, the cloud service access message is sent to the availability zone 2 where the target cloud service is deployed, and the cloud service access message is processed by the server in the availability zone 2, where the target cloud service is deployed at the server.

In some cloud platforms that require high availability and scalability, a load balancer (LB), also known as a load balance node, is usually used to distribute traffic and manage servers that deploy cloud services. Since the load balance node has a traffic scheduling capability, the management cost of the server may be reduced.

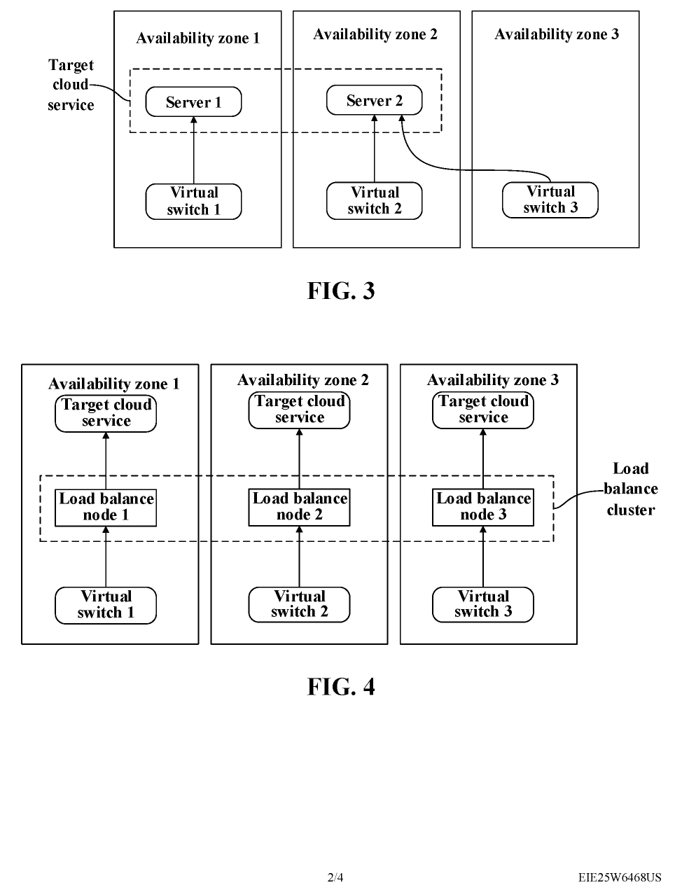

FIG. 4 is a schematic diagram of another cloud service deployed across availability zones provided by an embodiment of the present disclosure. The load balance cluster includes a load balance node 1, a load balance node 2, and a load balance node 3. The load balance node 1 is deployed in availability zone 1, the load balance node 2 is deployed in availability zone 2, and the load balance node 3 is deployed in availability zone 3. Since the load balance nodes are deployed across availability zones, when any availability zone fails, the load balancer may automatically reroute traffic to other availability zones that are operating normally, and the traffic is processed by the availability zones that are operating normally, thereby implementing high availability of the cloud service. In addition, the load balancer may also evenly distribute traffic among a plurality of availability zones to avoid a large load on a single availability zone and ensure reasonable use of resources.

In practical applications, the physical network address allocated for the destination virtual network address of the target cloud service may also be a physical network address allocated for each of the load balance nodes in the plurality of availability zones in which the target cloud service is deployed. Specifically, the target cloud service is deployed across the plurality of availability zones, each availability zone includes one or more load balance nodes, and the load balance node is also known as a load balancer. Both the load balancer (LB) and the target virtual private cloud gateway (RCM) belong to components in the virtual private cloud (VCP). The load balance nodes in the plurality of availability zones belong to a load balance cluster (LB cluster). As shown in FIG. 4, the load balance cluster is deployed in the plurality of availability zones, that is, the load balance cluster is deployed across the availability zones.

In the embodiment of the present disclosure, after the physical network address — belonging to the availability zone where the target cloud service is deployed and allocated to the availability zone of the virtual switch belongs — is determined as the destination physical network address according to the target mapping relationship maintained for the target cloud service, the cloud service access message may also be sent, based on the destination physical network address, to the load balance node in the availability zone corresponding to the destination physical network address. The cloud service access message is forwarded to the server where the target cloud service is deployed through the load balance node, and the cloud service access message is processed by the server where the target cloud service is deployed.

Exemplarily, after the cloud service access message carrying the destination virtual network address is received through the virtual switch 1, first, based on the availability zone 1 of the virtual switch 1, the physical network address vtep IP1 — belonging to the availability zone where the target cloud service is deployed and allocated to the availability zone 1 of the virtual — is determined from the target mapping relationship maintained for the target cloud service, as the destination physical network address. Then, the cloud service access message is sent to the availability zone corresponding to the destination physical network address, that is, the load balance node 1 in the availability zone 1. Next, the cloud service access message is forwarded by the load balance node 1 to the server in the availability zone 1, where the target cloud service is deployed at the server, and the cloud service access message is processed by the server.

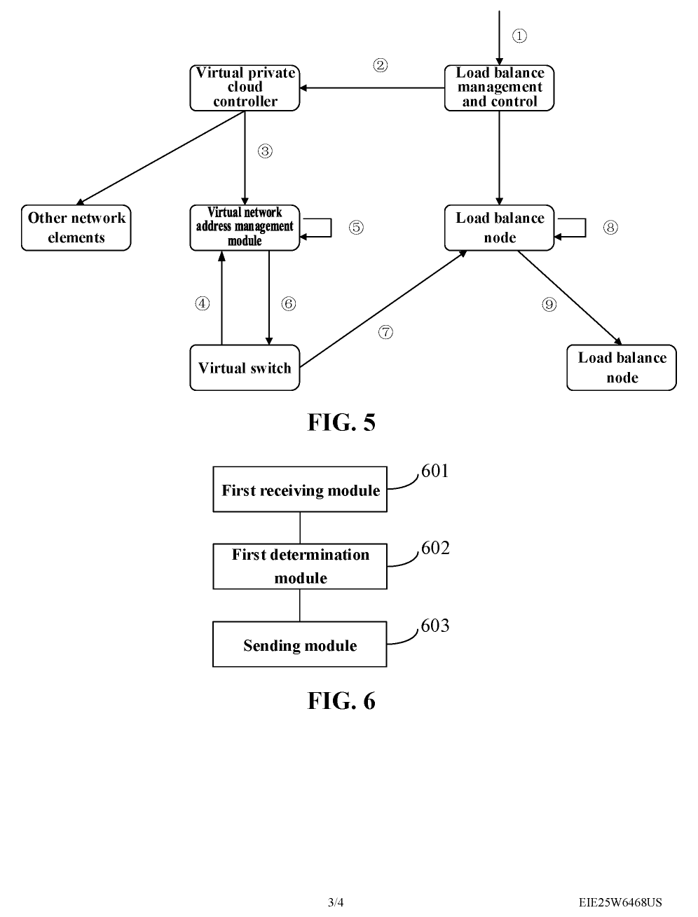

FIG. 5 is a flowchart of cloud service access processing provided by an embodiment of the present disclosure. As shown in FIG. 4, the virtual private cloud VPC includes components such as a VPC controller, a target virtual private cloud gateway (RCM), and a basic virtual switch (BVS). The flowchart shown in FIG. 4 mainly includes two stages. The first stage includes step ①, step ②, and step ③, and the first stage is mainly used to create a target cloud service. The second stage includes step ④, step ⑤, step ⑥, step ⑦, step ⑧, and step ⑨, and the second stage is mainly used to process the received cloud service access message.

Step ①: in the virtual private cloud VPC, a virtual network address service IP allocated for the target cloud service through an anycast address allocation mode is received by using LB management and control. Specifically, an LB instance is created, and the virtual network address service IP of the anycast type provided by the virtual private cloud VPC is used in the LB instance. Anycast, also known as unicast, broadcast, or anycast, is a network communication technology in the virtual private cloud. The virtual network address allocated to the source availability zone through the anycast address allocation mode has the function of high availability and proximity.

In practical applications, when the virtual network address is allocated through the anycast mode, an availability zone to which the virtual network address accesses proximately is specified. Generally, the availability zone to which the virtual network address accesses proximately is consistent with the availability zone to which the virtual switch belongs (that is, the availability zone in which the tenant server is deployed), and the range of the availability zone accessible by the tenant is the range of the availability zone in which the LB cluster is deployed.

Step ②: the virtual network address service IP allocated for the target cloud service through the anycast address allocation mode is received by load balance (LB) management and control, and a virtual tunnel endpoint network address vtep IP is allocated for each of a plurality of availability zones where the target cloud service is deployed, and the virtual tunnel endpoint network address vtep IP is sent to the VPC controller with a virtual network interface (ENI). The vtep IP refers to a physical network address with a virtual network function.

Step ③: the VPC controller is configured to manage the virtual network address in the VPC. After receiving the vtep IP allocated for each of the plurality of availability zones where the target cloud service is deployed, the VPC controller establishes a correspondence between the virtual network address service IP and the virtual tunnel endpoint network address vtep IP, and sends a target mapping relationship maintained for the target cloud service to the target virtual private cloud gateway (RCM), so that when there is a consumer to communicate subsequently, the RCM may determine, from the target mapping relationship maintained for the target cloud service and according to an identifier of the source availability zone, a physical network address of an availability zone where the target cloud service is deployed, which is allocated to the identifier of the source availability zone, as a destination physical network address.

Step ④: when receiving the cloud service access message, the virtual switch sends an address mapping request carrying an identifier of a source availability zone and the destination virtual network address to the target virtual private cloud gateway (RCM).

Step ⑤: the target virtual private cloud gateway (RCM) determines, from the target mapping relationship maintained for the target cloud service and according to the identifier of the source availability zone, a physical network address — belonging to the availability zone where the target cloud service is deployed and allocated to the availability zone of the virtual switch — as the destination physical network address.

If the destination physical network address corresponding to the identifier of the source availability zone is not determined from the target mapping relationship maintained for the target cloud service, a proximity access availability zone is determined for the source availability zone from the plurality of availability zones where the target cloud service is deployed, based on the availability zone topology information and the principle of geographical proximity. The physical network address, which is allocated by the proximity access availability zone for the destination virtual network address of the target cloud service, is used as the destination physical network address.

Step ⑥: the destination physical network address to the virtual switch is sent by the target virtual private cloud gateway (RCM).

Step ⑦: after receiving the destination physical network address, the virtual switch finds a load balance (LB) node of a proximity availability zone according to the destination physical network address, and sends the cloud service access message to the load balance (LB) node in the availability zone corresponding to the destination physical network address.

Step ⑧: after receiving the cloud service access message, the load balance (LB) node determines a server where the target cloud service is deployed based on a load balance algorithm.

Step ⑨: the cloud service access message is forwarded to the server where the target cloud service is deployed, so that the cloud service access message is processed by the server.

In the embodiment of the present disclosure, a target mapping relationship is maintained for the target cloud service, and the target mapping relationship records a physical network address of an availability zone where the target cloud service is deployed, which is allocated, according to a principle of geographical proximity, to a source availability zone requesting to access the target cloud service. Therefore, after a cloud service access message from any availability zone is received, a physical network address corresponding to a proximity availability zone may be determined as a destination physical network address of the cloud service access message based on the above mapping relationship, so that the cloud service access message is processed by a server in the proximity availability zone where the target cloud service is deployed, thereby reducing cloud service access latency and improving access message processing efficiency.

In order to implement the above embodiments, the present disclosure further provides a cloud service access processing apparatus. FIG. 6 is a schematic structural diagram of a cloud service access processing apparatus provided by an embodiment of the present disclosure. The apparatus may be implemented by software and/or hardware, and may generally be integrated in an electronic device. As shown in FIG. 6, the apparatus includes:

a first receiving module 601, configured to receive, through a virtual switch, a cloud service access message, the cloud service access message being used to indicate access to a target cloud service with a destination virtual network address, the target cloud service being deployed across a plurality of availability zones, each of the plurality of availability zones allocating a corresponding physical network address for the destination virtual network address of the target cloud service, and maintaining a target mapping relationship for the target cloud service, and the target mapping relationship recording a physical network address of an availability zone where the target cloud service is deployed, which is allocated, according to a principle of geographical proximity, to a source availability zone requesting to access the target cloud service;

a first determination module 602, configured to determine, according to the target mapping relationship maintained for the target cloud service, a physical network address of an availability zone where the target cloud service is deployed, which is allocated to an availability zone to which the virtual switch belongs, as a destination physical network address; and

a sending module 603, configured to send the cloud service access message to the availability zone corresponding to the destination physical network address, and process the cloud service access message through a server where the target cloud service is deployed in the availability zone.

In an optional implementation, the first determination module includes:

a first sending sub-module, configured to send, through the virtual switch, an address mapping request carrying an identifier of a source availability zone and the destination virtual network address to a target virtual private cloud gateway, and determine, by the target virtual private cloud gateway and according to the identifier of the source availability zone, the physical network address of the availability zone where the target cloud service is deployed, which is allocated to the source availability zone, from the target mapping relationship maintained for the target cloud service, as the destination physical network address; where the identifier of the source availability zone is used to identify the availability zone to which the virtual switch belongs.

In an optional implementation, the target mapping relationship maintained for the target cloud service further records a physical network address of an availability zone where the target cloud service is deployed, which is allocated, according to the principle of geographical proximity, to a source availability zone in which the target cloud service is not deployed.

In an optional implementation, the apparatus further includes:

a second determination module, configured to: in response to the target virtual private cloud gateway not determining, from the target mapping relationship maintained for the target cloud service, the physical network address of the availability zone where the target cloud service is deployed, which is allocated to the source availability zone; determine, based on availability zone topology information and the principle of geographical proximity, a proximity access availability zone for the source availability zone from the plurality of availability zones where the target cloud service is deployed; and determine a physical network address, which is allocated by the proximity access availability zone for the destination virtual network address of the target cloud service, as the destination physical network address; where the availability zone topology information is used to represent a geographical location relationship between the source availability zone and the plurality of availability zones.

In an optional implementation, the apparatus further includes:

a second receiving module, configured to receive a virtual network address allocated for a target cloud service through an anycast address allocation mode, and a virtual tunnel endpoint network address allocated for each of a plurality of availability zones where the target cloud service is deployed, the virtual tunnel endpoint network address being a physical network address allocated by a corresponding availability zone for the target cloud service.

In an optional implementation, the sending module includes:

a second sending sub-module, configured to send the cloud service access message to a load balance node in the availability zone corresponding to the destination physical network address; forward, through the load balance node, the cloud service access message to the server where the target cloud service is deployed in the availability zone; and process the cloud service access message by the server.

In an optional implementation, the apparatus further includes:

a deletion module, configured to: in response to the presence of an abnormal availability zone among the plurality of availability zones where the target cloud service is deployed, delete, from the target mapping relationship maintained for the target cloud service, a physical network address allocated by the abnormal availability zone for the destination virtual network address of the target cloud service.

In the cloud service access processing apparatus provided by the embodiment of the present disclosure, a cloud service access message is first received through a virtual switch, where the cloud service access message is used to indicate access to a target cloud service with a destination virtual network address, the target cloud service is deployed in each of a plurality of availability zones, and a target mapping relationship is maintained for the target cloud service, where the target mapping relationship records a physical network address of an availability zone and where the target cloud service is deployed, which is allocated, according to a principle of geographical proximity, to a source availability zone requesting to access the target cloud service; then, a physical network address of an availability zone where the target cloud service is deployed, which is allocated to an availability zone to which the virtual switch belongs, is determined as a destination physical network address according to the target mapping relationship maintained for the target cloud service; and then, the cloud service access message is sent to the availability zone corresponding to the destination physical network address, and the cloud service access message is processed through a server in the availability zone, where the target cloud service is deployed at the server.

In the embodiment of the present disclosure, a target mapping relationship is maintained for the target cloud service in advance, and the target mapping relationship records a physical network address of an availability zone where the target cloud service is deployed, which is allocated, according to a principle of geographical proximity, to a source availability zone requesting to access the target cloud service. Therefore, after a cloud service access message from any availability zone is received, a physical network address corresponding to a proximity availability zone may be determined as a destination physical network address of the cloud service access message based on the target mapping relationship, so that the cloud service access message is processed by a server in the proximity availability zone where the target cloud service is deployed, thereby reducing cloud service access latency and improving access message processing efficiency.

The cloud service access processing apparatus provided by the embodiment of the present disclosure may execute the cloud service access processing method provided by any embodiment of the present disclosure, and has corresponding functional modules and beneficial effects for executing the method.

In addition to the above methods and apparatuses, an embodiment of the present disclosure further provides a computer-readable storage medium, where instructions are stored in the computer-readable storage medium, and the instructions, when running on a terminal device, cause the terminal device to implement the cloud service access processing method according to the embodiment of the present disclosure.

An embodiment of the present disclosure further provides a computer program product, including a computer program/instruction, where the computer program/instruction implements the cloud service access processing method according to the embodiment of the present disclosure when being executed by a processor.

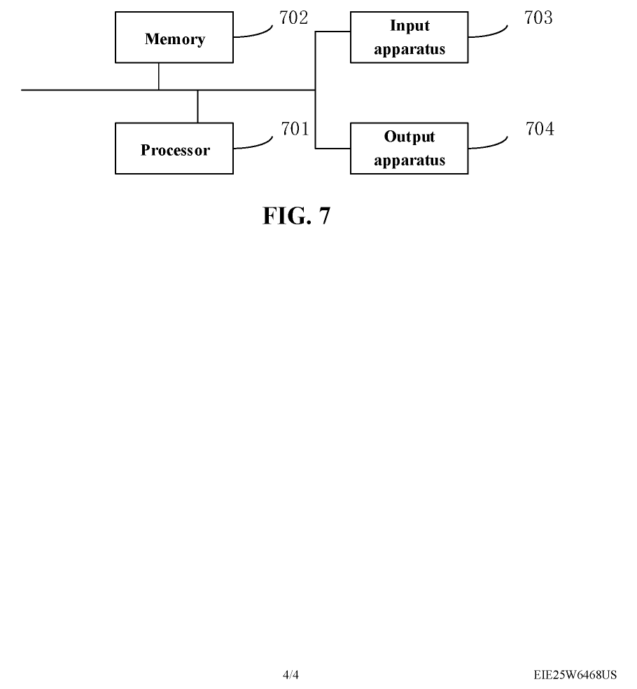

In addition, an embodiment of the present disclosure further provides a cloud service access processing device, which, as shown in FIG. 7, may include:

a processor 701, a memory 702, an input apparatus 703, and an output apparatus 704. The number of the processor 701 in the cloud service access processing device may be one or more, and one processor is used as an example in FIG. 7. In some embodiments of the present disclosure, the processor 701, the memory 702, the input apparatus 703, and the output apparatus 704 may be connected via a bus or in other ways, where connection through a bus is used as an example in FIG. 7.

The memory 702 may be used to store software programs and modules, and the processor 701 executes various functional applications and data processing of the cloud service access processing device by running the software programs and modules stored in the memory 702. The memory 702 may mainly include a program storage area and a data storage area, where the program storage area may store an operating system, an application program required by at least one function, etc. In addition, the memory 702 may include a high-speed random-access memory or a non-volatile memory, such as at least one magnetic disk storage device, a flash memory device, or other volatile solid-state storage devices. The input apparatus 703 may be used to receive input digital or character information and generate a signal input related to user settings and function control of the cloud service access processing device.

Specifically, in the present embodiment, the processor 701 will load an executable file corresponding to a process of one or more application programs into the memory 702 according to the following instructions, and the processor 701 will run the application programs stored in the memory 702 to implement various functions of the above cloud service access processing device.

It should be noted that in this article, relational terms such as “first” and “second” are only used to distinguish one entity or operation from another entity or operation, and do not necessarily require or imply any actual relationship or order between these entities or operations. Moreover, the terms “include/comprise”, “contain” or any other variant thereof are intended to cover non-exclusive inclusion, so that a process, method, object or device including a series of elements includes not only those elements, but also other elements not explicitly listed or elements inherent to such process, method, object or device. Without further restrictions, an element defined by the phrase “includes a...” does not exclude the existence of additional identical elements in the process, method, object or device that includes the element.

The above descriptions are only specific implementations of the present disclosure, so that those skilled in the art may understand or implement the present disclosure. Various modifications to these embodiments will be obvious to those skilled in the art, and general principles defined herein may be implemented in other embodiments without departing from the spirit or scope of the present disclosure. Therefore, the present disclosure will not be limited to the embodiments described herein, but rather to the widest scope consistent with the principles and novel features disclosed herein.

1/We claim:

1. A cloud service access processing method, comprising:
receiving, through a virtual switch, a cloud service access message, the cloud service access message being used to indicate access to a target cloud service with a destination virtual network address, the target cloud service being deployed across a plurality of availability zones, each of the plurality of availability zones allocating a corresponding physical network address for the destination virtual network address of the target cloud service, and maintaining a target mapping relationship for the target cloud service, and the target mapping relationship recording a physical network address of an availability zone where the target cloud service is deployed, which is allocated, according to a principle of geographical proximity, to a source availability zone requesting to access the target cloud service;
determining, according to the target mapping relationship maintained for the target cloud service, a physical network address of an availability zone where the target cloud service is deployed, which is allocated to an availability zone to which the virtual switch belongs, as a destination physical network address; and
sending the cloud service access message to the availability zone corresponding to the destination physical network address, and processing the cloud service access message through a server where the target cloud service is deployed in the availability zone.

2. The method of claim 1, wherein determining, according to the target mapping relationship maintained for the target cloud service, the physical network address of the availability zone where the target cloud service is deployed, which is allocated to the availability zone to which the virtual switch belongs, as the destination physical network address comprises:
sending, through the virtual switch, an address mapping request carrying an identifier of a source availability zone and the destination virtual network address to a target virtual private cloud gateway, and
determining, by the target virtual private cloud gateway and according to the identifier of the source availability zone, the physical network address of the availability zone where the target cloud service is deployed, which is allocated to the source availability zone, from the target mapping relationship maintained for the target cloud service, as the destination physical network address, the identifier of the source availability zone being used to identify the availability zone to which the virtual switch belongs.

3. The method of claim 2, wherein the target mapping relationship maintained for the target cloud service further records a physical network address of an availability zone where the target cloud service is deployed, which is allocated, according to the principle of geographical proximity, to a source availability zone where the target cloud service is not deployed.

4. The method of claim 2, further comprising:
in response to the target virtual private cloud gateway not determining, from the target mapping relationship maintained for the target cloud service, the physical network address of the availability zone where the target cloud service is deployed, which is allocated to the source availability zone, determining, based on availability zone topology information and the principle of geographical proximity, a proximity access availability zone for the source availability zone from the plurality of availability zones where the target cloud service is deployed; and determining a physical network address, which is allocated by the proximity access availability zone for the destination virtual network address of the target cloud service, as the destination physical network address; wherein the availability zone topology information is used to represent a geographical location relationship between the source availability zone and the plurality of availability zones.

5. The method of claim 1, wherein before receiving, through the virtual switch, the cloud service access message, the method further comprises:
receiving a virtual network address allocated for a target cloud service through an anycast address allocation mode, and a virtual tunnel endpoint network address allocated for each of the plurality of availability zones where the target cloud service is deployed, the virtual tunnel endpoint network address being a physical network address allocated by a corresponding availability zone for the target cloud service.

6. The method of claim 1, wherein sending the cloud service access message to the availability zone corresponding to the destination physical network address, and processing the cloud service access message through the server where the target cloud service is deployed in the availability zone comprises:
sending the cloud service access message to a load balance node in the availability zone corresponding to the destination physical network address;
forwarding, through the load balance node, the cloud service access message to the server where the target cloud service is deployed in the availability zone; and
processing the cloud service access message by the server.

7. The method of claim 1, further comprising:
in response to the presence of an abnormal availability zone among the plurality of availability zones where the target cloud service is deployed, deleting, from the target mapping relationship maintained for the target cloud service, a physical network address allocated by the abnormal availability zone for the destination virtual network address of the target cloud service.

8. An electronic device, comprising:
a processor;
a memory, configured to store instructions executable by the processor, wherein
the processor is configured to read the instructions from the memory, and the instructions are configured to be executed by the processor to:
receive, through a virtual switch, a cloud service access message, the cloud service access message being used to indicate access to a target cloud service with a destination virtual network address, the target cloud service being deployed across a plurality of availability zones, each of the plurality of availability zones allocating a corresponding physical network address for the destination virtual network address of the target cloud service, and maintaining a target mapping relationship for the target cloud service, and the target mapping relationship recording a physical network address of an availability zone where the target cloud service is deployed, which is allocated, according to a principle of geographical proximity, to a source availability zone requesting to access the target cloud service;
determine, according to the target mapping relationship maintained for the target cloud service, a physical network address of an availability zone where the target cloud service is deployed, which is allocated to an availability zone to which the virtual switch belongs, as a destination physical network address; and
send the cloud service access message to the availability zone corresponding to the destination physical network address, and process the cloud service access message through a server where the target cloud service is deployed in the availability zone.

9. The electronic device of claim 8, wherein the instructions configured to determine, according to the target mapping relationship maintained for the target cloud service, the physical network address of the availability zone where the target cloud service is deployed, which is allocated to the availability zone to which the virtual switch belongs, as the destination physical network address are further configured to:
send, through the virtual switch, an address mapping request carrying an identifier of a source availability zone and the destination virtual network address to a target virtual private cloud gateway, and
determine, by the target virtual private cloud gateway and according to the identifier of the source availability zone, the physical network address of the availability zone where the target cloud service is deployed, which is allocated to the source availability zone, from the target mapping relationship maintained for the target cloud service, as the destination physical network address, the identifier of the source availability zone being used to identify the availability zone to which the virtual switch belongs.

10. The electronic device of claim 9, wherein the target mapping relationship maintained for the target cloud service further records a physical network address of an availability zone where the target cloud service is deployed, which is allocated, according to the principle of geographical proximity, to a source availability zone where the target cloud service is not deployed.

11. The electronic device of claim 9, the instructions are further configured to be executed by the processor to:
in response to the target virtual private cloud gateway not determining, from the target mapping relationship maintained for the target cloud service, the physical network address of the availability zone where the target cloud service is deployed, which is allocated to the source availability zone, determine, based on availability zone topology information and the principle of geographical proximity, a proximity access availability zone for the source availability zone from the plurality of availability zones where the target cloud service is deployed; and determine a physical network address, which is allocated by the proximity access availability zone for the destination virtual network address of the target cloud service, as the destination physical network address; wherein the availability zone topology information is used to represent a geographical location relationship between the source availability zone and the plurality of availability zones.

12. The electronic device of claim 8, wherein before receiving, through the virtual switch, the cloud service access message, the instructions are configured to be executed by the processor to:
receive a virtual network address allocated for a target cloud service through an anycast address allocation mode, and a virtual tunnel endpoint network address allocated for each of the plurality of availability zones where the target cloud service is deployed, the virtual tunnel endpoint network address being a physical network address allocated by a corresponding availability zone for the target cloud service.

13. The electronic device of claim 8, wherein the instructions configured to send the cloud service access message to the availability zone corresponding to the destination physical network address, and process the cloud service access message through the server where the target cloud service is deployed in the availability zone are further configured to:
send the cloud service access message to a load balance node in the availability zone corresponding to the destination physical network address;
forward, through the load balance node, the cloud service access message to the server where the target cloud service is deployed in the availability zone; and
process the cloud service access message by the server.

14. The electronic device of claim 8, the instructions are further configured to be executed by the processor to:
in response to the presence of an abnormal availability zone among the plurality of availability zones where the target cloud service is deployed, delete, from the target mapping relationship maintained for the target cloud service, a physical network address allocated by the abnormal availability zone for the destination virtual network address of the target cloud service.

15. A non-transitory computer-readable storage medium, wherein the storage medium stores a computer program, and the computer program is used to:
receive, through a virtual switch, a cloud service access message, the cloud service access message being used to indicate access to a target cloud service with a destination virtual network address, the target cloud service being deployed across a plurality of availability zones, each of the plurality of availability zones allocating a corresponding physical network address for the destination virtual network address of the target cloud service, and maintaining a target mapping relationship for the target cloud service, and the target mapping relationship recording a physical network address of an availability zone where the target cloud service is deployed, which is allocated, according to a principle of geographical proximity, to a source availability zone requesting to access the target cloud service;
determine, according to the target mapping relationship maintained for the target cloud service, a physical network address of an availability zone where the target cloud service is deployed, which is allocated to an availability zone to which the virtual switch belongs, as a destination physical network address; and
send the cloud service access message to the availability zone corresponding to the destination physical network address, and process the cloud service access message through a server where the target cloud service is deployed in the availability zone.

16. The medium of claim 15, wherein the computer program used to determine, according to the target mapping relationship maintained for the target cloud service, the physical network address of the availability zone where the target cloud service is deployed, which is allocated to the availability zone to which the virtual switch belongs, as the destination physical network address is further used to:
send, through the virtual switch, an address mapping request carrying an identifier of a source availability zone and the destination virtual network address to a target virtual private cloud gateway, and
determine, by the target virtual private cloud gateway and according to the identifier of the source availability zone, the physical network address of the availability zone where the target cloud service is deployed, which is allocated to the source availability zone, from the target mapping relationship maintained for the target cloud service, as the destination physical network address, the identifier of the source availability zone being used to identify the availability zone to which the virtual switch belongs.

17. The medium of claim 16, wherein the target mapping relationship maintained for the target cloud service further records a physical network address of an availability zone where the target cloud service is deployed, which is allocated, according to the principle of geographical proximity, to a source availability zone where the target cloud service is not deployed.

18. The medium of claim 16, the computer program is further used to:
in response to the target virtual private cloud gateway not determining, from the target mapping relationship maintained for the target cloud service, the physical network address of the availability zone where the target cloud service is deployed, which is allocated to the source availability zone, determine, based on availability zone topology information and the principle of geographical proximity, a proximity access availability zone for the source availability zone from the plurality of availability zones where the target cloud service is deployed; and determine a physical network address, which is allocated by the proximity access availability zone for the destination virtual network address of the target cloud service, as the destination physical network address; wherein the availability zone topology information is used to represent a geographical location relationship between the source availability zone and the plurality of availability zones.

19. The medium of claim 15, wherein before receiving, through the virtual switch, the cloud service access message, the computer program is further used to:
receive a virtual network address allocated for a target cloud service through an anycast address allocation mode, and a virtual tunnel endpoint network address allocated for each of the plurality of availability zones where the target cloud service is deployed, the virtual tunnel endpoint network address being a physical network address allocated by a corresponding availability zone for the target cloud service.

20. The medium of claim 15, wherein the computer program used to send the cloud service access message to the availability zone corresponding to the destination physical network address, and process the cloud service access message through the server where the target cloud service is deployed in the availability zone the computer program is further used to:
send the cloud service access message to a load balance node in the availability zone corresponding to the destination physical network address;
forward, through the load balance node, the cloud service access message to the server where the target cloud service is deployed in the availability zone; and
process the cloud service access message by the server.
